(19) United States
(12) Patent Application Publication
(10) Pub. No.: US 2025/0238553 A1
(43) Pub. Date: Jul. 24, 2025

(54) PERFORMING INTEGRITY VERIFICATION OF CONTENT IN A VIDEO CONFERENCE USING LIGHTING ADJUSTMENT

(71) Applicant: Google LLC, Mountain View, CA (US)

(72) Inventor: Stefan Lindmark, Östhammar (SE)

(21) Appl. No.: 18/420,236

(22) Filed: Jan. 23, 2024

(51) Int. Cl. G06F 21/64; G06T 7/90; G06T 11/00; G06V 20/40; G06V 40/40

(52) U.S. Cl. CPC G06F 21/64; G06T 7/90; G06T 11/001; G06V 20/41; G06V 40/40; G06T 2200/24; G06T 2207/10016; G06T 2207/10024; G06T 2207/20084; G06T 2207/30201

(57) ABSTRACT

Systems and methods for performing integrity verification of content in a video conference using lighting adjustment are provided. An example method includes determining that an integrity verification of video content generated by a first client device of a plurality of client devices of a plurality of participants of a video conference is to be performed; causing a modified UI comprising one or more visual items, each corresponding to a video stream, to be presented on the first client device, wherein the UI was modified using a color pattern encoding; receiving, from the first client device, a video stream generated by the first client device subsequent to a presentation of the modified UI on the first client device; and verifying the integrity of the video content generated by the first client device based on the video stream generated by the first client device and the color pattern encoding.

### TECHNICAL FIELD

Aspects and implementations of the present disclosure relate to performing integrity verification of content in a video conference using lighting adjustment.

### BACKGROUND

Video conferences can take place between multiple participants via a video conference platform. A video conference platform includes tools that allow multiple client devices to be connected over a network and share each other's audio (e.g., the voice of a user recorded via a microphone of a client device) and/or video stream (e.g., a video captured by a camera of a client device, or video captured from a screen image of the client device) for communication. In some instances, malicious actors can inject fake content and/or generated content (e.g., a “deepfake”) into a video stream of one or more participants during the video conference, which can be difficult to detect. Such fake content and/or generated content can threaten the integrity of information communicated during the video conference and decrease the level of trust that participants have in the overall video conference platform.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes determining that an integrity verification of video content generated by a first client device of a plurality of client devices of a plurality of participants of a video conference is to be performed, and causing a modified user interface (UI), comprising one or more visual items each corresponding to a video stream generated by one of the plurality of client devices, to be presented on the first client device, wherein the UI was modified using a color pattern encoding. The method further includes receiving, from the first client device, a video stream generated by the first client device subsequent to a presentation of the modified UI on the first client device, and verifying the integrity of the video content generated by the first client device based on the video stream generated by the first client device and the color pattern encoding.

In some embodiments, the color pattern encoding modifies a plurality of frames presented in the modified UI, each of the plurality of frames comprises a first subset of pixels with a modified first color pattern and a second subset of pixels with a modified second color pattern.

In some embodiments, the first subset of pixels with the modified first color pattern and the second subset of pixels with the modified second color pattern correspond to the one or more visual items in the modified UI.

In some embodiments, the modified first color pattern comprises a first red-green-blue (RGB) color, and the modified second color pattern comprises a second RGB color that is complementary to the first RGB color, wherein the first RGB color and the second RGB color are selected such that combined color modifications maintain color neutrality of the modified UI.

In some embodiments, the plurality of frames comprises a first sub-plurality of frames and a second sub-plurality of frames, wherein colors of the first subset of pixels and the second subset of pixels in the first sub-plurality of frames are different from colors of the first subset of pixels and the second subset of pixels in the second sub-plurality of frames.

In some embodiments, the first sub-plurality of frames is displayed for a first set of time periods and the second sub-plurality of frames is displayed for a second set of time periods.

In some embodiments, the first set of time periods and the second set of time periods are determined using a pseudo-random sequence.

In some embodiments, the modified UI is displayed during a live phase of the video conference or during a preparation phase of the video conference.

In some embodiments, the video stream generated by the first client device subsequent to the presentation of the modified UI reflects color changes to one or more objects in an image captured by a camera of the first client device, wherein the color changes are caused by the color pattern encoding modifying illumination of the one or more objects by a display of the first client device.

In some embodiments, to verify the integrity of the video content generated by the first client device, the method further includes providing the video stream generated by the first client device and the color pattern encoding as input to a trained artificial intelligence (AI) model; receiving an output of the trained AI model, the output indicating a likelihood of a color pattern of the video stream corresponding to the color pattern encoding; and upon determining that the likelihood satisfies a threshold criterion, confirming the integrity of the video content generated by the first client device.

In some embodiments, verifying the integrity of the video content generated by the first client device is further based on latency between causing the modified UI to be presented on the first client device and receiving, from the first client device, the video stream generated by the first client device subsequent to the presentation of the modified UI on the first client device.

In some embodiments, determining that the integrity verification of the video content generated by the first client device is to be performed comprises at least one of: receiving a request from a first participant of the plurality of participants of the video conference; receiving an indication of a start of the video conference; or detecting, using a plurality of rules, one or more candidate integrity verification threats, wherein the one or more candidate integrity verification threats pertains to one or more of: a connection pattern, a network condition, an internet protocol (IP) geolocation, a virtual private network (VPN) use, or a number of connection attempts.

In some embodiments, a computer-readable storage medium (which may be a non-transitory computer-readable storage medium, although the invention is not limited to that) stores instructions which, when executed, cause a processing device to perform operations comprising a method according to any embodiment or aspect described herein.

In some embodiments, a system comprises: a memory device; and a processing device operatively coupled with the memory device to perform operations comprising a method according to any embodiment or aspect described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2A illustrates an example user interface (UI) on a client device during a video conference, in accordance with implementations of the present disclosure.

FIG. 2B illustrates an example user interface (UI) on a client device during a video conference, in accordance with implementations of the present disclosure.

FIG. 2C illustrates an example user interface (UI) on a client device during a video conference, in accordance with implementations of the present disclosure.

FIG. 2D illustrates an example user interface (UI) on a client device during a video conference, in accordance with implementations of the present disclosure.

FIG. 3 depicts an example schematic diagram of a pseudo-random sequence encoded into a digital signal, in accordance with implementations of the present disclosure.

FIG. 4A depicts a flow diagram of a method for performing integrity verification of content in a video conference using lighting adjustment, in accordance with implementations of the present disclosure.

FIG. 4B depicts a flow diagram of a method for utilizing an artificial intelligence (AI) model to verify integrity of content generated by a client device of a video conference participant.

FIG. 5 is a block diagram illustrating an exemplary computer system, in accordance with implementations of the present disclosure.

### DETAILED DESCRIPTION

Aspects of the present disclosure relate to performing integrity verification of content in a video conference of a video conference platform using lighting adjustment. A video conference platform can enable video-based conferences between multiple participants via respective client devices that are connected over a network and share each other's audio (e.g., the voice of a user recorded via a microphone of a client device) and/or video streams (e.g., a video captured by a camera of a client device) during a video conference. In some instances, a video conference platform can enable a significant number of client devices (e.g., up to one hundred or more client devices) to be connected via the video conference.

Some video conference platforms can provide a user interface (UI) to each client device connected to the video conference, where the UI displays the video streams of each participant shared over the network in a display of each client device. In some instances, malicious actors can inject fake content and/or generated content (e.g., a “deepfake”) into a video stream of one or more participants during the video conference (e.g., for the purpose of impersonation), such that the deepfake appears in the UI on one or more client devices of the one or more participants. A deepfake can refer to content that is generated, e.g., using artificial intelligence (AI) and/or machine learning techniques, to manipulate audio, images, and/or videos to depict events, situations, or individuals that may not have occurred or existed in reality. Deepfakes typically utilize deep learning algorithms, such as Generative Adversarial Networks (GANs) or other deep neural network architectures, to create or alter content that appears authentic and realistic. Due to the convincing appearance of deepfakes, it can be difficult for a video conference platform or participants of a video conference to detect video streams that have been manipulated using deepfakes. Further, although some video conference platforms can use compliance standards that provide ways to verify or certify chains for content sources and/or processing history of content (e.g., the content in video streams), such compliance standards would typically require complete chains of compliance where the use of a single, uncertified component (e.g., a non-upgradeable camera) could potentially break the entire chain, which can result in disruptions to a video conference. As such, malicious actors can use undetected deepfakes to spread misinformation, create fraudulent content, manipulate media that deceives or misleads participants of a video conference, and overall threaten the integrity of information communicated during a video conference. Further, the difficulty in detecting deepfakes during a video conference can lead to a decrease in the level of trust that participants have in the video conference platform.

Implementations of the present disclosure address the above and other deficiencies by performing integrity verification (e.g., to detect deepfakes) of content in a video conference of a video conference platform. In some implementations, integrity verification is performed by causing a real-time change to a video conference participant's environment to be introduced at the sending side, and then analyzing a video stream associated with the video conference participant at the receiving side to determine whether the introduced change is appropriately reflected in the video stream (e.g., matches predictions of where and when the change should occur). In some implementations, for better protection from malicious actors, real-time changes can be performed in a non-predictable manner (to avoid possible replications by malicious actors). In some implementations, the analysis of the video stream can include measuring how quickly the change is reflected within the video stream (since video conferencing platforms operate under low latency, and deepfake processing may not be done without introducing latency).

In some implementations, the real-time change can be introduced by manipulating the color of projected light. Specifically, the color of lighting projected on particular content in a participant's video stream can be manipulated using the display of a client device since such a display can be used as a light source during a video conference. For example, in a client device such as a laptop or mobile device, a display technology is used to emit light to display images. To create a full-color image, displays can use various technologies to produce pixels of individual color output, where each pixel may output its color based on a blend of multiple subpixels, where each subpixel can contribute a red, green, or blue color of varying brightness. The resulting pixel color is often referred to as the combination of its red, green, and blue (RGB) color. By varying the brightness of each sub-pixel, the display can create a wide range of colors. By combining the different colors and/or brightness levels of the sub-pixels, the display can create the desired color and/or brightness for each pixel. The emitted color of each pixel is visible to the eye of a user observing the display. At the same time, each pixel also emits light that contributes to the illumination of the environment in which the display is located. The location of each pixel on the physical display determines the angle with which the emitted light from each pixel will add to the illumination of objects in the environment of the display.

As discussed above, in some implementations, to introduce a real-time change to a participant's environment, a video conference platform can rely on lightning functionality of the display of a client device during a video conference to adjust the color of lighting projected on particular content in a participant's video stream. Specifically, the video conference platform can adjust the color and/or brightness of pixels of a videoconference user interface displayed on a participant's client device. For better protection from malicious actors, the video conference platform can adjust the color and/or brightness in a non-predictable manner, e.g., according to a pseudo-random sequence that can be generated to specify a pattern in which to adjust the color and/or brightness. The adjusted color and/or brightness of the pixels of the UI can then be reflected in the color changes to one or more objects (e.g., face of the participant) in one or more images captured by the camera of the client device of the participant, and the resulting video stream generated by the camera of the client device of the participant can be sent to the video conference platform. On the receiving side, the video conference platform can analyze the video stream to determine whether the color changes to the one or more objects correspond to the adjustments to the color and/or brightness in the UI. The video conference platform can further measure the responsiveness (e.g., latency) of how quickly the adjustments to the color and/or brightness are reflected within the video stream. If the color changes to the one or more objects in the video stream can be correlated to the adjustments to the color and/or brightness in the UI, and optionally the measured latency satisfies (e.g., is equal to or less than) a target latency criterion (that is based on latency of the video conference platform), the video conference platform can determine that the integrity verification of the participant's video stream is satisfied (e.g., that there is no deepfake detected in the video stream).

Aspects of the present disclosure provide technical advantages over previous solutions. Aspects of the present disclosure can provide an additional functionality to the video conference tool of the video conference platform that improves the detectability of deepfakes in a video conference such that participants can communicate with each other more effectively without compromising information integrity. Further, by providing an additional functionality to the video conference tool of the video conference platform, aspects of the present disclosure can be used to detect deepfakes in a video conference without having to rely on external sources or additional hardware by exploiting the real-time execution nature of the video conference platform, where malicious actors are limited to using deepfakes without pre-rendered content or using a limited set of pre-rendered content that can be spliced together in real time but with inflexible usage. Further, the video conference platform can use the display of the client device itself for providing lighting adjustment to detect the deepfakes, thus resulting in more efficient use of processing resources utilized to facilitate the connection between client devices by avoiding consumption of additional computing resources needed to detect deepfakes in the video conference.

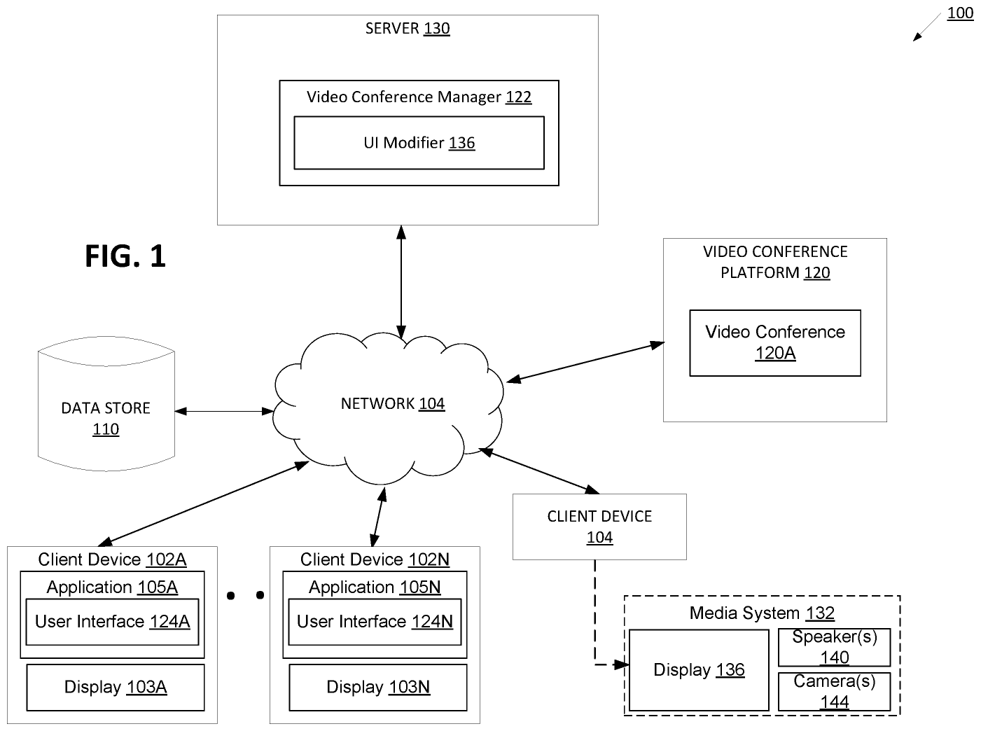

FIG. 1 illustrates an example system architecture 100, in accordance with implementations of the present disclosure. The system architecture 100 (also referred to as “system” herein) includes client devices 102A-N, one or more client devices 104, a data store 110, a video conference platform 120, and a server 130, each connected to a network 104.

In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

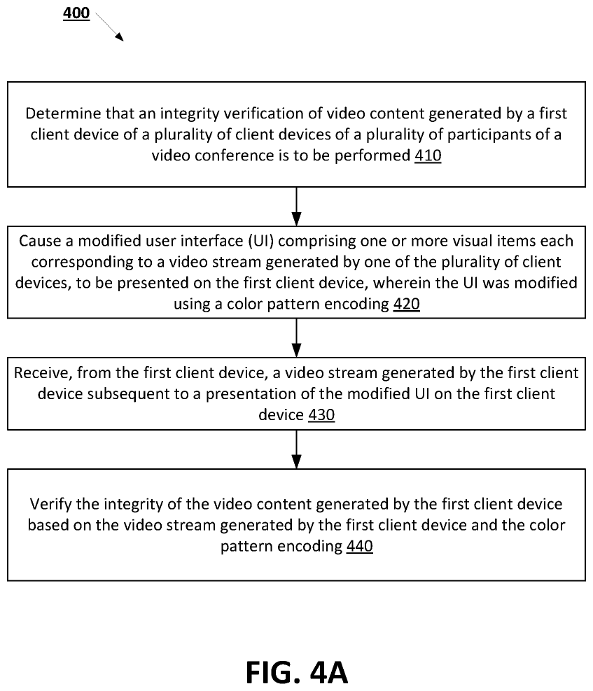

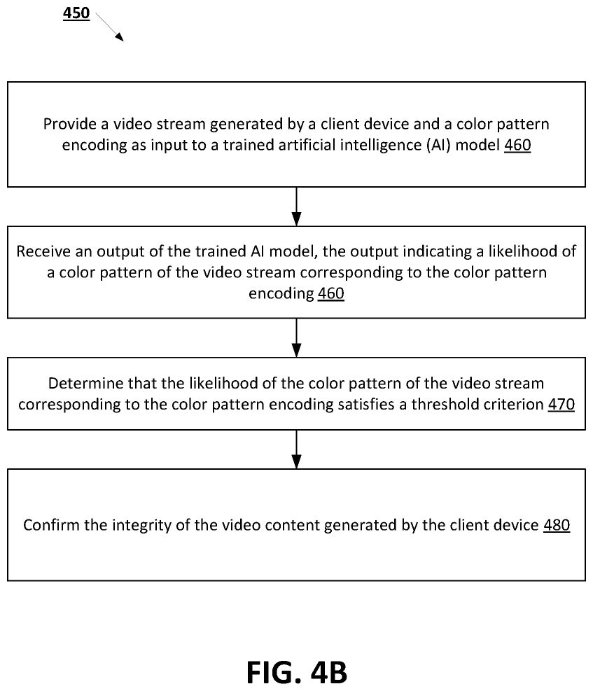

In some implementations, data store 110 is a persistent storage that is capable of storing data as well as data structures to tag, organize, and index the data. A data item can include audio data and/or video stream data, in accordance with embodiments described herein. Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by video conference platform 120 or one or more different machines (e.g., the server 130) coupled to the video conference platform 120 via network 104. In some implementations, the data store 110 can store portions of audio and video streams received from the client devices 102A-102N for the video conference platform 120. Moreover, the data store 110 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents may be shared with users of the client devices 102A-102N and/or concurrently editable by the users. In some implementations, the data store 110 can store one or brightness levels and/or color patterns (also referred to herein as “colors”) of visual items and/or UI elements received from the client devices 102A-102N and/or determined by the server 130, as described in more detail with respect to FIG. 4A. A visual item can refer to a UI element that occupies a particular region in the UI and is dedicated to presenting the video stream from a client device of the virtual meeting participant. In some implementations, the data store 110 can store a target color pattern modification criterion, one or more pseudo-random sequences, a trained machine learning model to determine a set of elements pertaining to facial features detected in a video stream of a participant in a video conference of the video conference platform 120, a target latency criterion, one or more latency values of the video conference platform 120, and/or a set of rules for detecting one or more candidate integrity verification threats in a video conference, as described in more detail with respect to FIG. 4A.

Video conference platform 120 can enable users of client devices 102A-102N and/or client device(s) 104 to connect with each other via a video conference (e.g., a video conference 120A). A video conference (also referred to herein as a “live stream of a video conference”) refers to a real-time communication session such as a video conference call, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. Video conference platform 120 can allow a user to join and participate in a video conference call with other users of the platform. Embodiments of the present disclosure can be implemented with any number of participants connecting via the video conference (e.g., up to one hundred or more).

The client devices 102A-102N may each include computing devices such as personal computers (PCs), laptops, mobile phones, smart phones, tablet computers, netbook computers, network-connected televisions, etc. In some implementations, client devices 102A-102N may also be referred to as “user devices.” Each client device 102A-102N can include an audiovisual component that can generate audio and video data to be streamed to video conference platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-102N. In some implementations, the audiovisual component can also include an image capture device (e.g., a camera) to capture images and generate video data (e.g., a video stream) of the captured data of the captured images.

In some embodiments, video conference platform 120 is coupled, via network 104, with one or more client devices 104 that are each associated with a physical conference or meeting room. Client device(s) 104 may include or be coupled to a media system 132 that may comprise one or more display devices 136, one or more speakers 140 and one or more cameras 144. Display device 136 can be, for example, a smart display or a non-smart display (e.g., a display that is not itself configured to connect to network 104). Users that are physically present in the room can use media system 132 rather than their own devices (e.g., client devices 102A-102N) to participate in a video conference, which may include other remote users. For example, the users in the room that participate in the video conference may control the display 136 to show a slide presentation or watch slide presentations of other participants. Sound and/or camera control can similarly be performed. Similar to client devices 102A-102N, client device(s) 104 can generate audio and video data to be streamed to video conference platform 120 (e.g., using one or more microphones, speakers 140 and cameras 144).

Each client device 102A-102N or 104 can include a web browser and/or a client application (e.g., a mobile application, a desktop application, etc.). In some implementations, the web browser and/or the client application can present, on a display device 103A-103N of client device 102A-102N, a user interface (UI) (e.g., a UI of the UIs 124A-124N) for users to access video conference platform 120. For example, a user of client device 102A can join and participate in a video conference via a UI 124A presented on the display device 103A by the web browser or client application. A user can also present a document to participants of the video conference via each of the UIs 124A-124N. Each of the UIs 124A-124N can include multiple regions to present visual items corresponding to video streams of the client devices 102A-102N provided to the server 130 for the video conference. Each of the UIs 124A-124N can include UI elements, including buttons, icons, text fields, sliders, and other objects that can enable a user of client device 102A-102N to interact with participants of the video conference.

In some implementations, server 130 can include a video conference manager 122. Video conference manager 122 is configured to manage a video conference between multiple users of video conference platform 120. In some implementations, video conference manager 122 can provide the UIs 124A-124N to each client device to enable users to watch and listen to each other during a live stream of a video conference and/or during playback of a recording of the video conference. Video conference manager 122 can also collect and provide data associated with the video conference to each participant of the video conference. In some implementations, video conference manager 122 can provide the UIs 124A-124N for presentation by client applications 105A-105N (e.g., mobile applications, desktop applications, etc.). For example, the UI 124A-124N can be displayed on a display device 103A-103N by a client application 105A-105N executing on the operating system of the client device 102A-102N or the client device 104. In some implementations, video conference manager 122 can provide partial video conference UIs 124A-124N to corresponding client applications 105A-105N, and corresponding client applications 105A-105N may finalize the UIs 124A-124N for display on the display devices 103A-103N. The client application may be a web browser or a component of a web browser, or be an application or component separate from a web browser.

In some embodiments, the video conference manager 122 can perform integrity verification of content generated during the video conference by causing a real-time change to a video conference participant's environment to be introduced on the sending side, and then analyzing a video stream associated with the video conference participant at the receiving side to determine whether the introduced change is appropriately reflected in the video stream (e.g., matches predictions of where and when the change should occur). In some implementations, the real-time change can be introduced by manipulating the color of lighting projected on particular objects in a video stream of client device 102A-102N (which generates content that is the subject of integrity verification) can be manipulated using display device 103A-103N of client device 103A-103N. In some implementations, the video conference manager 122 includes UI modifier 136 that can cause the color and/or brightness of pixels of UI 124A-124N displayed on display device 103A-103N of client device 102A-102N to be adjusted using a color pattern encoding. For example, the UI modifier 136 can perform the adjustment of the color and/or brightness of pixels of UI 124A-124N using the color pattern encoding. Alternatively, the UI modifier 136 can provide information defining the color pattern encoding to client application 105A-105N with instructions to perform the adjustment of the color and/or brightness of pixels of UI 124A-124N using this color pattern encoding, and the client application 105A-105N will perform the requested modifications and present the modified UI 124A-124N on display device 103A-103N of client device 102A-102N. Further details with respect to the video conference manager 122 are described with respect to FIG. 4A.

As described previously, an audiovisual component of each client device can capture images and generate video data (e.g., a video stream) of the captured data of the captured images. In some implementations, the client devices 102A-102N and/or client device(s) 104 can transmit the generated video stream to video conference manager 122. The audiovisual component of each client device can also capture an audio signal representing speech of a user and generate audio data (e.g., an audio file or audio stream) based on the captured audio signal. In some implementations, the client devices 102A-102N and/or client device(s) 104 can transmit the generated audio data to video conference manager 122. The video conference manager 122 can include a video stream processor. The video stream processor can be combined together or separated into further components, according to a particular implementation. It should be noted that in some implementations, various components of the video conference manager 122 may run on separate machines. The video stream processor can receive video streams from the client devices (e.g., from client devices 102A-102N and/or 104). In some implementations, the video stream processor can receive audio streams associated with the video streams from the client devices (e.g., from an audiovisual component of the client devices 102A-102N).

In some implementations, video conference platform 120 and/or server 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a video conference. Video conference platform 120 may also include a website (e.g., a webpage) or application back-end software that may be used to enable a user to connect with other users via the video conference.

It should be noted that in some other implementations, the functions of server 130 or video conference platform 120 may be provided by a fewer number of machines. For example, in some implementations, server 130 may be integrated into a single machine, while in other implementations, server 130 may be integrated into multiple machines. In addition, in some implementations, server 130 may be integrated into video conference platform 120.

In general, functions described in implementations as being performed by video conference platform 120 or server 130 can also be performed by the client devices 102A-N and/or client device(s) 104 in other implementations, if appropriate. In addition, the functionality attributed to a particular component can be performed by different or multiple components operating together. Video conference platform 120 and/or server 130 can also be accessed as a service provided to other systems or devices through appropriate application programming interfaces, and thus is not limited to use in websites.

Although implementations of the disclosure are discussed in terms of video conference platform 120 and users of video conference platform 120 participating in a video conference, implementations may also be generally applied to any type of telephone call, conference call or virtual meeting between users. Implementations of the disclosure are not limited to video conference platforms that provide video conference tools to users.

In implementations of the disclosure, a “user” may be represented as a single individual. However, other implementations of the disclosure encompass a “user” being an entity controlled by a set of users and/or an automated source. For example, a set of individual users federated as a community in a social network may be considered a “user.” In another example, an automated consumer may be an automated ingestion pipeline, such as a topic channel, of the video conference platform 120.

In situations in which the systems discussed here collect personal information about users, or may make use of personal information, the users may be provided with an opportunity to control whether video conference platform 120 collects user information (e.g., information about a user's social network, social actions or activities, profession, a user's preferences, or a user's current location), or to control whether and/or how to receive content from the server 130 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the video conference platform 120 and/or server 130.

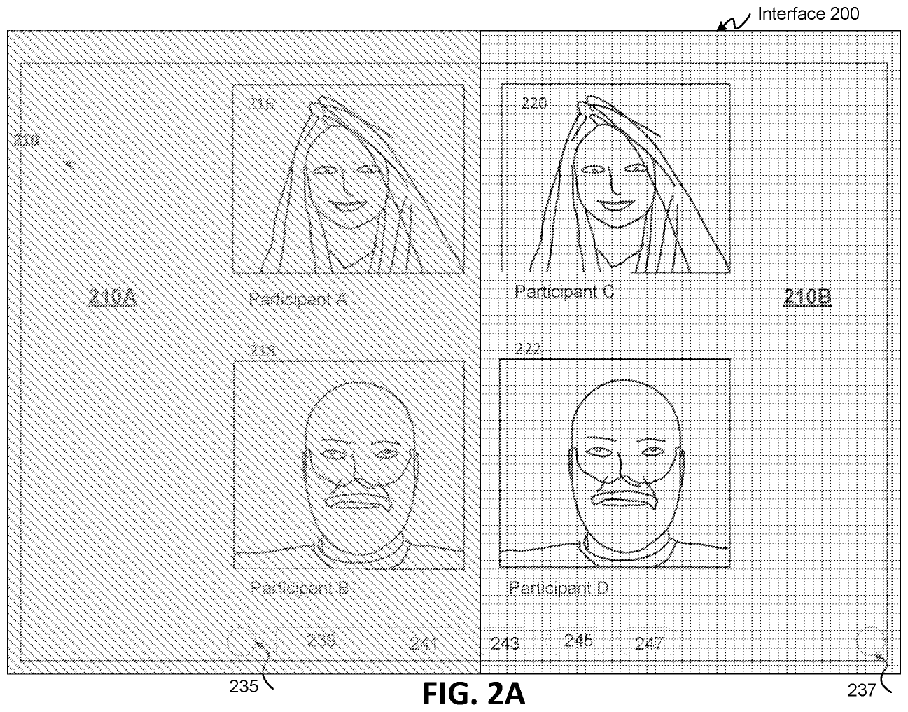

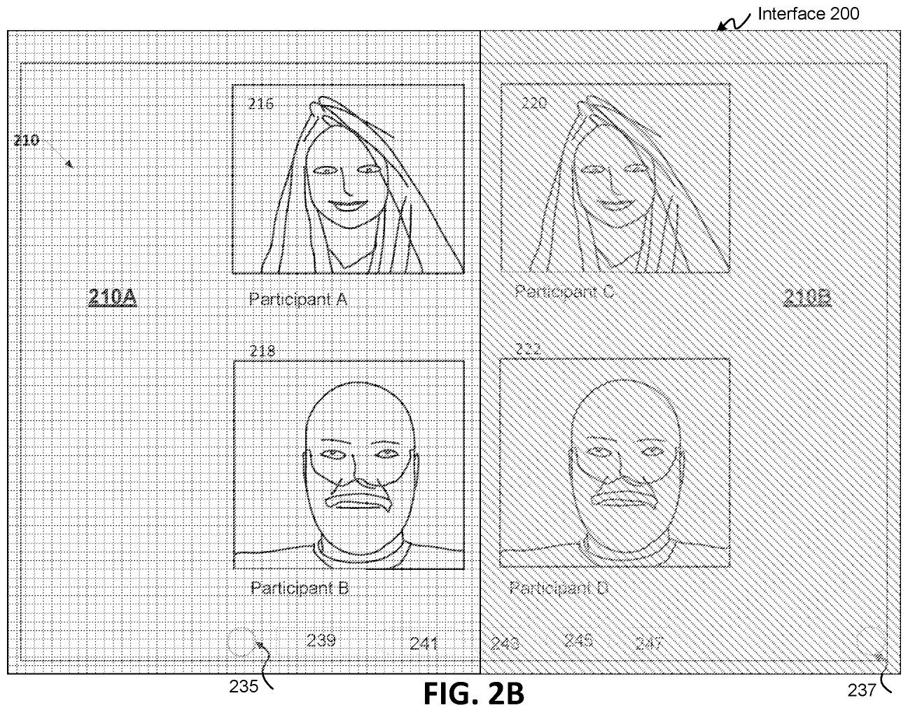

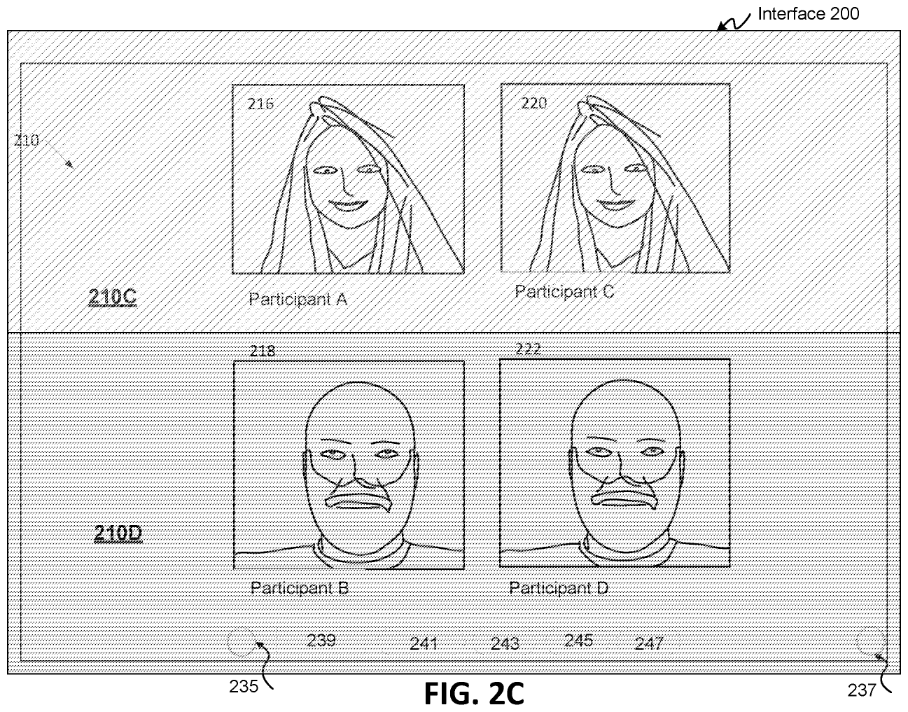

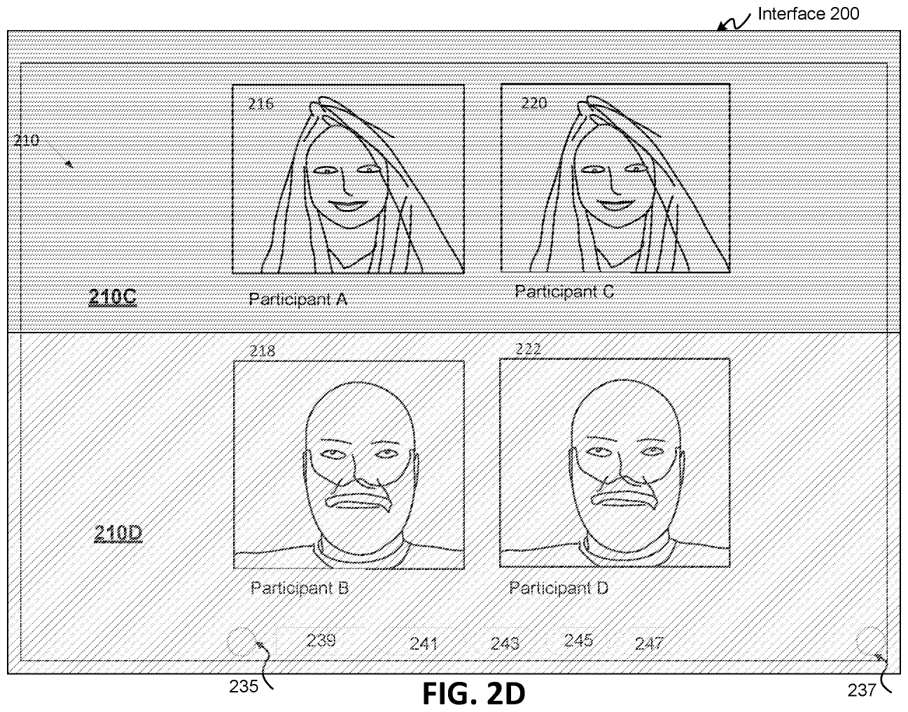

FIG. 2A illustrates an example user interface 200 on a client device during a video conference, in accordance with some embodiments of the present disclosure. The UI 200 can be generated by the video conference manager 122 of FIG. 1 for presentation at a client device (e.g., client devices 102A-102N and/or 104). Accordingly, the UI 200 can be generated by one or more processing devices of the server 130 of FIG. 1. In some implementations, the video conference between multiple participants can be managed by the video conference platform 120. As illustrated, the video conference manager 122 can provide the UI 200 to enable participants (e.g., participants A, B, C, D) to join and participate in the video conference. Alternatively, the UI 200 can be generated by a client application (e.g., application 105A-105N) hosted by a respective client device (e.g., client devices 102A-102N and/or 104) based on data received from the server 130. Yet alternatively, video conference manager 122 can provide partial UI 200 to a client application hosted by the client device, and the corresponding client application may finalize the UI 200 (e.g., by modifying the provided UI as discussed herein, adding content generated by the client device such as images and/or a video stream generated by a camera of the client device, etc.).

UI 200 can include one or more regions. In the illustrated example, UI 200 includes a first region 216, a second region 218, a third region 220, and a fourth region 222. The first region 216 can display a visual item corresponding to video data (e.g., a video stream) captured and/or generated and/or streamed by a client device associated with Participant A (e.g., based on an identifier associated with the client device and/or the participant). The second region 218 can display a visual item corresponding to video data (e.g., a video stream) captured and/or generated and/or streamed by a client device associated with Participant B (e.g., based on an identifier associated with the client device and/or the participant). The third region 220 can display a visual item corresponding to video data (e.g., a video stream) captured and/or generated and/or streamed by a client device associated with Participant C (e.g., based on an identifier associated with the client device and/or the participant). The fourth region 222 can display a visual item corresponding to video data (e.g., a video stream) captured and/or generated and/or streamed by a client device associated with Participant D (e.g., based on an identifier associated with the client device and/or the participant). In some implementations, each region is of the same or similar size as the size of each other region. In some implementations, each region can be of different sizes, e.g., one region can be of a larger size than the other regions.

In some embodiments, the UI 200 can include one or more UI elements that enable participants to interact with other participants in the video conference. For example, the one or more UI elements can include an icon, button, text field, slider, drop-down, or other objects to enable participants to interact during the video conference, such as UI elements 235, 239, 241, 243, 245, 247, 237 of FIG. 2A.

As discussed above, the UI 200 can be adjusted using a color pattern encoding. The color pattern encoding can be intended to modify frames presented in the UI 200 by modifying, for each frame, a color pattern (first color pattern) of one subset of pixels (first subset of pixels) and a color pattern (second color pattern) of another subset of pixels (second subset of pixels) presented in the UI 200. For example, the UI 200 can include a region 210 including visual items 216, 218, 220 and 222 and background areas. As used herein, the term “background” may refer to an area in a participant's visual item that surrounds the image of the participant. The background may include a real physical background, which may include a location and one or more objects near the participant and that are viewable from the participant's video camera. The background may include a virtual background, which may include an image over which an image of the participant is superimposed and replaces the participant's real physical background during the virtual meeting.

In some implementations, as illustrated in FIG. 2A, the first subset of pixels can be a left half 210A of the region 210 including visual items 216, 218 and corresponding background area, and the second subset of pixels can be a right half 210B of the region 210 including visual items 220, 222 and corresponding background area. In some implementations, as illustrated in FIG. 2B, the first subset of pixels can be a top half 210C including visual items 216, 220 and corresponding background area, and the second subset of pixels can be a bottom half 210D of the region 210 including visual items 218, 222 and corresponding background area. In some implementations, the first subset of pixels and the second subset of pixels can be segmented using other types of patterns. The color pattern encoding can define a modified first color pattern including a red-green-blue (RGB) color (e.g., red) and a modified second color pattern including another RGB color that is complementary to the modified first color pattern (e.g., an RGB color that is complementary to red, such as cyan). The brightness level of the second RGB color can be matched to the identified brightness level of the first RGB color. For example, the brightness level of the first RGB color and the second RGB color can be matched by matching each of the first RGB color and the second RGB color to an equal luminance. The color patterns and/or brightness levels can be selected such that their combined color modifications maintain color neutrality of the UI. For example, the color pattern encoding can set the first subset of pixels to display the first RGB color, and the second subset of pixels to display the second RGB color, such that the first subset of pixels displays red and the second subset of pixels displays cyan with a brightness level matched to the brightness level of the red (herein referred to as “phase 1”). It should be noted that region 210 can be of any size and can include one or more background areas, one or more visual items presented in the video conference UI, or any combination of the above.

In some implementations, region 210 can be included in the frames of the UI 200 during a preparation phase of the video conference. The preparation phase may include presentation of a UI of the application 105A that allows the participant to prepare for entering the video conference. While in the preparation phase, video or audio from the participant's client device may not be streamed to client devices of other participants. The preparation phase may allow the participant to adjust audio or microphone levels, get positioned in front of the camera of the client device, or perform other video conference preparation tasks. Alternatively, region 210 can be included in the frames of the UI 200 during a live phase of the video conference. A live phase may refer to a phase in which video conference participants are able to interact with each other (e.g., view or hear each other in real-time (or near real-time due to transmission delays, etc.) during the video conference).

In some embodiments, the color pattern encoding can define or be associated with a pseudo-random sequence specifying the color of pixels of the subsets of pixels of the region 210 described with reference to FIGS. 2A-2D for different frames and how long they should be displayed. In some embodiments, the frames can have a first subset of frames and a second subset of frames. The respective color shift of each subset of pixels in the second subset of frames can be opposite to the initial color shift that each subset of pixels has in the first subset of frames, and the first subset of frames can be displayed for a first set of time periods while the second subset of frames can be displayed for a second set of time periods. For example, the initial color shift that each subset of pixels has in the first subset of frames can be illustrated in FIG. 2A (e.g., using the patterned lines in the left half 210A of the region 210 and the patterned lines in the right half 210B of the region 210), and the respective color shift of each subset of pixels in the second subset of frames can be illustrated in FIG. 2B (e.g., indicated by switching of the patterned lines in the left half 210A of the region 210 and the patterned lines in the right half 210B of the region 210). Referring to FIGS. 2C-2D, the initial color shift that each subset of pixels has in the first subset of frames can be illustrated in FIG. 2C (e.g., using the patterned lines in the top half 210C of the region 210 and the patterned lines in the bottom half 210D of the region 210), and the respective color shift of each subset of pixels in the second subset of frames can be illustrated in FIG. 2D (e.g., indicated by switching of the patterned lines in the top half 210C of the region 210 and the patterned lines in the bottom half 210D of the region 210). For example, the pseudo-random sequence can include a sequence of numbers (e.g., a sequence of 8-bit numbers), where each number is associated with a time slice (e.g., a time period) for swapping the first RGB color displayed in the first subset of pixels with the second RGB color displayed in the second subset of pixels (e.g., such that the first subset of pixels displays the cyan, and the second subset of pixels displays the red) (herein referred to as “phase 2”). For example, the pseudo-random sequence can be “02140410,” where each number in the pseudo-random sequence is associated with a particular time slice in a time cycle. In some implementations, the particular time slice associated with a number in the pseudo-random sequence can be predefined (e.g., based on experimental data and offline testing) and stored in a data structure accessible to the video conference manager 122 (e.g., the data store 110 of FIG. 1). For example, a time cycle can be defined as a period of time, such as 600 milliseconds. “0” can be associated with 100 milliseconds in phase 2 followed by 500 milliseconds in phase 1, “1” can be associated with 200 milliseconds in phase 2 and 400 milliseconds in phase 1, “2” can be associated with 300 milliseconds in phase 2 and 300 milliseconds in phase 1, “3” can be associated with 400 milliseconds in phase 2 and 200 milliseconds in phase 1, “4” can be associated with 500 milliseconds in phase 2 and 100 milliseconds in phase 2, etc. The video conference manager 122 can send the pseudo-random sequence to the client device for modification of the UI 200 by the client application.

The above color pattern encoding modifies illumination of objects (e.g., facial features of the video conference participant) in the video conference participant's environment by the display device 103, which causes color changes to the objects in the image captured by a camera of the client device 102. These color changes are then reflected in the video stream generated by the camera of the client device 102. The server can receive the video stream and analyze it to determine whether the above color changes match predictions of where and when the changes should occur, as discussed in more detail herein.

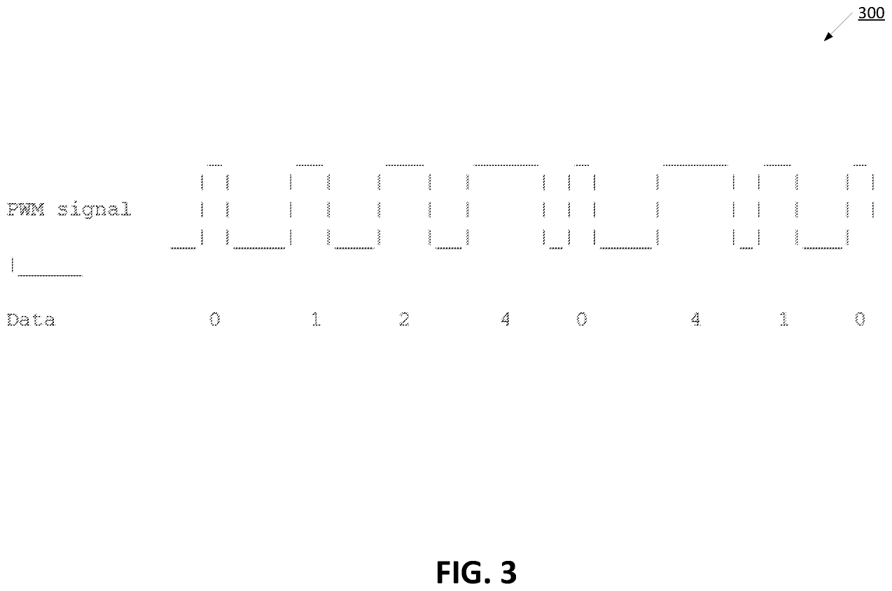

FIG. 3 depicts an example schematic diagram of a pseudo-random sequence encoded into a digital signal, in accordance with implementations of the present disclosure. The pseudo-random sequence can be identified (e.g., generated) at a server, e.g., the server 130 of FIG. 1, using a random number generator. In some implementations, the pseudo-random sequence can be sent to a client device for modification of the video conference UI by encoding the pseudo-random sequence into a digital signal, such as the digital signal 300 depicted in FIG. 3. For example, the encoding of the pseudo-random sequence can be performed using pulse width modulation (PWM), which encodes analog information in a digital signal by varying the width of pulses in a fixed time period. The server can map a number (e.g., an 8-bit number) to a particular pulse width, where each pulse width represents a particular time slice within a time cycle. For example, using the aforementioned example described with respect to FIG. 2A, a pseudo-random sequence can be a sequence of numbers, such as “02140410.” A time cycle can be defined as a period of time, such as 600 milliseconds. As illustrated in FIG. 3, each time cycle can start with a leading (e.g., vertical) edge of a pulse as a phase change from phase 1 to phase 2. “0” can be associated with a pulse width representing 100 milliseconds of the time cycle in phase 2 followed by a pulse width representing 500 milliseconds of the time cycle in phase 1, “1” can be associated with a pulse width representing 200 milliseconds of the time cycle in phase 2 followed by a pulse width representing 400 milliseconds of the time cycle in phase 1, “2” can be associated with a pulse width representing 300 milliseconds of the time cycle in phase 2 followed by a pulse width representing 300 milliseconds of the time cycle in phase 1, “3” can be associated with a pulse width representing 400 milliseconds of the time cycle in phase 2 followed by a pulse width representing 200 milliseconds of the time cycle in phase 1, “4” can be associated with a pulse width representing 500 milliseconds of the time cycle in phase 2 followed by a pulse width representing 100 milliseconds of the time cycle in phase 2, etc. In some implementations, the client device can include a receiver that can decode the encoded pseudo-random sequence.

FIGS. 4A and 4B depict flow diagrams of methods for performing integrity verification of content in a video conference, in accordance with implementations of the present disclosure. Methods may be performed by processing logic that may include hardware (circuitry, dedicated logic, etc.), software (e.g., instructions run on a processing device), or a combination thereof. In one implementation, some or all the operations of method 400 may be performed by one or more components of system 100 of FIG. 1 (e.g., video conference platform 120, server 130 and/or video conference manager 122).

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the method 400 in accordance with the disclosed subject matter. In addition, those skilled in the art will understand and appreciate that the method 400 could alternatively be represented as a series of interrelated states via a state diagram or events. Additionally, it should be appreciated that the method 400 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

FIG. 4A depicts a flow diagram of method 400 for performing integrity verification of content in a video conference using lighting adjustment, in accordance with implementations of the present disclosure. Referring to FIG. 4A, at block 410, the processing logic determines that an integrity verification of video content generated by a client device (e.g., a first client device) of a set of client devices (e.g., the client devices 102A-102N and/or 104 of FIG. 1) of a set of participants of a video conference is to be performed. In some embodiments, the video content can include a video stream generated by a client device of the set of client devices (e.g., the first client device). In some embodiments, the video stream corresponds to a visual item that is presented in a user interface (UI) (e.g., a UI 124A of the UIs 124A-124N of FIG. 1) on the client device. In some embodiments, the UI includes a set of regions to display a set of visual items, where each visual item corresponds to one of a set of video streams from the set of client devices. For example, the UI can include the set of regions 216, 218, 220, 222 of FIGS. 2A-2D. In some embodiments, a video stream can correspond to a series of images captured by a camera of a client device and subsequently encoded for transmission over a network in accordance with, for example, H.264 standard. In some embodiments, the video stream can correspond to screen image data of a document presented on a display device of a client device. A document can be a slide presentation, a word document, a spreadsheet document, a web page, or any other document that can be presented. In some embodiments, each video stream can be associated with an audio stream corresponding to audio data collected by a microphone of a client device and subsequently encoded (e.g., compressed and packetized) for transmission over a network. The audio data can be encoded according to a standard such as MP3, etc. In some embodiments, each visual item can be associated with a brightness level.

In some embodiments, the processing logic determines that the integrity verification of the video content is to be performed in response to receiving a request from a participant of the set of participants, where a first UI element of a set of UI elements presented in the UI is selectable, by the participant, to request to perform the integrity verification. In some embodiments, the set of UI elements can include an icon, button, text field, slider, drop-down, or other objects to enable participants to interact during the video conference, such as one of the UI elements 235, 239, 241, 243, 245, and/or 247 illustrated in FIGS. 2A-2D. In some embodiments, the processing logic determines that the integrity verification of the video content is to be performed in response to receiving an indication of a start of the video conference. In some embodiments, the processing logic determines that the integrity verification of the video content is to be performed in response to detecting, using a set of rules, one or more candidate integrity verification threats. For example, the one or more candidate integrity verification threats can pertain to one or more of: a connection pattern, a network condition, an internet protocol (IP) geolocation, a virtual private network (VPN) use, and/or a number of connection attempts. In some embodiments, the set of rules and the one or more candidate integrity verification threats can be retrieved from a data structure, e.g., the data store 110 of FIG. 1. In some embodiments, the set of rules and the one or more candidate integrity verification threats can be identified based on experimental data and offline testing.

At block 420, the processing logic causes a modified UI (e.g., a UI 124A of the UIs 124A-124N of FIG. 1), which includes one or more visual items each corresponding to a video stream generated by a client device of a video conference participant, to be presented on the client device (e.g., the first client device). In some embodiments, the UI was modified using a color pattern encoding that is intended to adjust frames presented in the UI. The frames can be adjusted by modifying, for each frame, a first color pattern of a first subset of pixels and a second color pattern for a second subset of pixels. In some embodiments, the first subset of pixels with the modified first color pattern and the second subset of pixels with the modified second color pattern are superimposed on one or more visual items in the modified UI.

In some embodiments, the modified first color pattern includes a first red-green-blue (RGB) color, and the modified second color pattern includes a second RGB color that is complementary to the first RGB color, where the first RGB color and the second RGB color are selected such that their combined modifications maintain color neutrality of the modified UI. In some embodiments, the frames being adjusted include a first sub-plurality of frames and a second sub-plurality of frames, where the colors of the first subset of pixels and the second subset of pixels in the first sub-plurality of frames are different from the colors of the first subset of pixels and the second subset of pixels in the second sub-plurality of frames. In some embodiments, the first sub-plurality of frames is displayed for a first set of time periods and the second sub-plurality of frames is displayed for a second set of time periods, where the first set of time periods and the second set of time periods are determined using a pseudo-random sequence.

As illustrated in FIGS. 2A-2D, the processing logic can segment region 210 into a first subset of pixels and a second subset of pixels. In some embodiments, the processing logic can identify the first color pattern to be modified by selecting any red-green-blue (RGB) color, such as red. The processing logic can identify the second color pattern to be modified, where identifying the second color pattern to be modified includes determining a second RGB color that is complementary to the first color pattern (e.g., an RGB color that is complementary to red, such as cyan). The processing logic can identify a brightness level of the first RGB color (e.g., a brightness level of the red RGB color). In some embodiments, the processing logic can determine the brightness level of the first RGB color by measuring the relative luminance of the region 210 at a particular display frame of the video conference. Relative luminance is a measure from a scale of 0 to 1 of the perceived brightness of a color and can be used to determine the brightness of each pixel in a display. To determine the relative luminance of the region 210, the processing logic can determine a brightness level of each pixel of the region 210, where each pixel of the region 210 includes a set of subpixels that each correspond to a red-green-blue (RGB) color of an RGB color model. For example, there can be three subpixels, where one subpixel corresponds to a red color component, another subpixel corresponds to a green color component, and another subpixel corresponds to a blue color component of each pixel of the visual item. An example formula for determining the relative luminance of the region 210 can be the following:

$$Y = {n}_{1} \times R + {n}_{2} \times G + {n}_{3} \times B ,$$

where Y is the relative luminance (from 0 to 1), R is the red color component (from 0 to 255), G is the green color component (from 0 to 255), B is the blue color component (from 0 to 255), and n₁, n₂, n₃ are linear coefficients typically known in the art (e.g., n₁ can be 0.2126, n₂ can be 0.7152, n₃ can be 0.0722). For example, if a particular pixel of the region 210 has an RGB value of (128, 64, 255), the processing logic can determine the relative luminance as follows: Y=0.2126×128+0.7152×64+0.0722×255, resulting in Y=84.68. The resulting value of Y (84.68) represents the relative luminance of the color of the particular pixel of the visual item, which can be used as a measure of the brightness level of the particular pixel. In some embodiments, the processing logic can compute a sum of the brightness levels of the individual pixels of each region 210 (e.g., by adding the relative luminance measured for each pixel of each visual item) (also referred to herein as “Cₙ”).

The processing logic can identify a brightness level of the second RGB color in a similar manner as described with respect to identifying the brightness level of the first RGB color. The processing logic can match the brightness level of the second RGB color with the identified brightness level of the first RGB color. For example, the brightness level of the first RGB color and the second RGB color can be matched by matching each of the first RGB color and the second RGB color to an equal luminance, which can be matched using mathematical formulas typically known in the art. The processing logic can modify the first subset of pixels to display the first RGB color, and the second subset of pixels to display the second RGB color, such that the first subset of pixels displays red and the second subset of pixels displays cyan with a matched brightness level to the brightness level of the red (herein referred to as “phase 1”).

In some embodiments, the processing logic can cause the first color pattern (e.g., the first RGB color) and the second color pattern (e.g., the second RGB color with the matched brightness level to the first RGB color) to be modified by causing the first color pattern to be swapped, at an initial or an n display frame of the video stream, with the second color pattern for an interval of time corresponding to a time slice associated with each number included a pseudo-random sequence generated by a server (e.g., the server 130 of FIG. 1). For example, the processing logic can identify (e.g., generate), at the server, the pseudo-random sequence that includes a sequence of numbers, where each number is associated with a time slice (e.g., a time period) for swapping the first RGB color displayed in the first subset of pixels with the second RGB color displayed in the second subset of pixels (e.g., such that the first subset of pixels is modified to display cyan and the second subset of pixels is modified to display red) (herein referred to as “phase 2”). For example, the pseudo-random sequence can be “02130410,” where each number in the pseudo-random sequence is associated with a particular time slice in a time cycle. Further details related to the pseudo-random sequence are described with respect to FIG. 3.

The above color pattern encoding modifies illumination of objects (e.g., facial features of the participant using the first client device) in the participant's environment by the display device of the first client device, which causes color changes to the objects in the image captured by a camera of the first client device. These color changes are then reflected in the video stream generated by the camera of the first client device and sent to the server.

At block 430, the processing logic receives, from the first client device, a video stream generated by the first client device subsequent to the presentation of the modified UI on the first client device. As discussed above, the video stream generated by the first client device subsequent to the presentation of the modified UI reflects color changes to one or more objects in the image captured by the camera of the first client device, where the color changes are caused by the color pattern encoding modifying illumination of the objects by the display device of the first client device.

At block 440, the processing logic verifies the integrity of the video content generated by the first client device based on the video stream generated by the first client device and the color pattern encoding. One embodiment of such integrity verification is discussed in more detail below with reference to FIG. 4B.

FIG. 4B depicts a flow diagram of a method for utilizing an artificial intelligence (AI) model to verify integrity of content generated by a client device of a video conference participant. Referring to FIG. 4B, at block 460, processing logic provides the video stream and the color pattern encoding as input to the AI model. In some embodiments, the AI model may include one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron may be connected to one or more neurons via one or more edges (“synapses”). The synapses may perpetuate a signal from one neuron to another, and a weight, bias, or other configuration of a neuron or synapse may adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

ANNs may learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one embodiment, the AI model may be a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), a large language model (LLM), or a diffusion model. In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some embodiments, the AI model has been trained on a corpus of training data using supervised, or unsupervised training. The training data may include content data of historical video streams generated after changes to environments of respective users were introduced using certain color pattern encodings. In supervised training, the training data may also include target outputs indicating whether the introduced changes were reflected in the respective video streams as expected.

At block 460, processing logic receives one or more outputs of the trained AI model. The outputs can indicate a likelihood of a color pattern of the video stream corresponding to the color pattern encoding.

At block 470, the processing logic determines that the likelihood of the color pattern of the video stream corresponding to the color pattern encoding satisfies a threshold criterion (e.g., is higher than 75 percent).

At block 480, the processing logic confirms the integrity of the video content generated by the first client device. Alternatively, if the processing logic determines that the likelihood of the color pattern of the video stream corresponding to the color pattern encoding does not satisfy the threshold criterion, the processing logic can generate a notification to inform a designated user or one or more other participants of the video conference that the integrity of video content generated by the first client device, or perform other actions (e.g., terminating or suspending the video conference).

In some embodiments, the processing logic also uses latency to verify the integrity of the video content generated by the first client device by measuring how quickly the color changes are reflected within the video stream. For example, the processing logic can measure a latency value between causing the modified UI to be presented on the client device and receiving the video stream, and determine that the measured latency value satisfies (e.g., is equal to or less than) a target latency criterion. In some embodiments, the target latency criterion can be a latency value (e.g., a constant latency value) determined using offline testing, such as A/B testing. A/B testing, also known as split testing, can refer to a randomized experimentation process where two or more versions of a variable are shown to different groups (e.g., groups of users) at the same time, and their performance is compared.

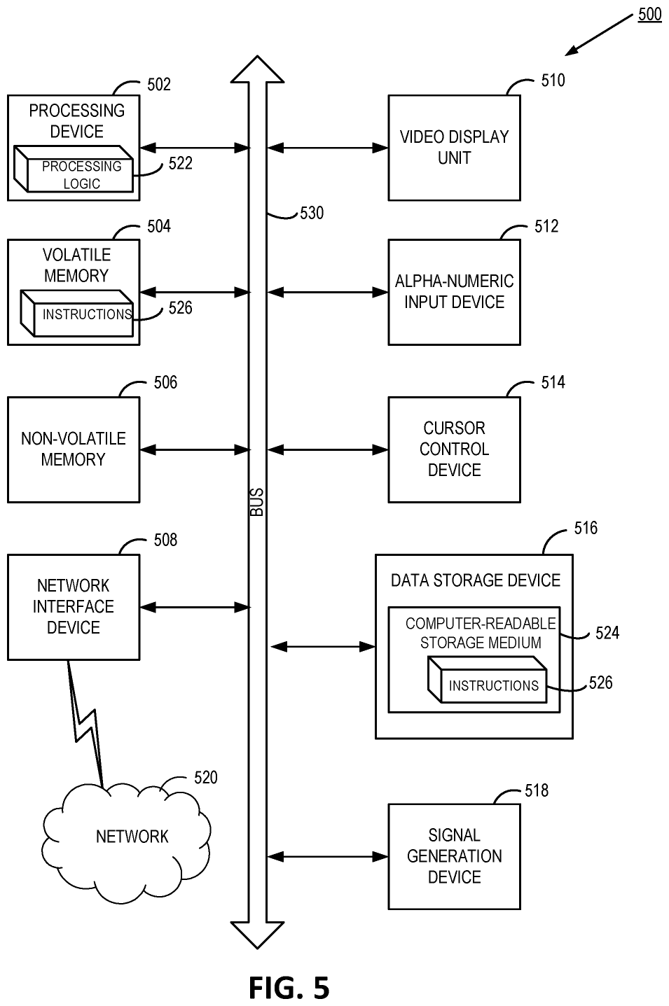

FIG. 5 is a block diagram illustrating an exemplary computer system, in accordance with implementations of the present disclosure. The computer system 500 can be the server 130 or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., read-only memory (ROM), flash memory, dynamic random access memory (DRAM) such as synchronous DRAM (SDRAM), double data rate (DDR SDRAM), or DRAM (RDRAM), etc.), a static memory 506 (e.g., flash memory, static random access memory (SRAM), etc.), and a data storage device 516, which communicate with each other via a bus 530.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 526 (e.g., for performing integrity verification of content in a video conference using lighting adjustment) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker).

The data storage device 516 can include a non-transitory machine-readable storage medium 524 (also computer-readable storage medium) on which is stored one or more sets of instructions 526 (e.g., for performing integrity verification of content in a video conference using lighting adjustment) embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 520 via the network interface device 508.

In one implementation, the instructions 526 include instructions for performing integrity verification of content in a video conference using lighting adjustment. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
determining that an integrity verification of video content generated by a first client device of a plurality of client devices of a plurality of participants of a video conference is to be performed;
causing a modified user interface (UI) comprising one or more visual items, each corresponding to a video stream generated by one of the plurality of client devices, to be presented on the first client device, wherein the UI was modified using a color pattern encoding;
receive, from the first client device, a video stream generated by the first client device subsequent to a presentation of the modified UI on the first client device; and
verify the integrity of the video content generated by the first client device based on the video stream generated by the first client device and the color pattern encoding.

2. The method of claim 1, wherein the color pattern encoding modifies a plurality of frames presented in the modified UI, each of the plurality of frames comprises a first subset of pixels with a modified first color pattern and a second subset of pixels with a modified second color pattern.

3. The method of claim 2, wherein the first subset of pixels with the modified first color pattern and the second subset of pixels with the modified second color pattern correspond to the one or more visual items in the modified UI.

4. The method of claim 2, wherein the modified first color pattern comprises a first red-green-blue (RGB) color, and the modified second color pattern comprises a second RGB color that is complementary to the first RGB color, and wherein the first RGB color and the second RGB color are selected such that combined color modifications maintain color neutrality of the modified UI.

5. The method of claim 2, wherein the plurality of frames comprises a first sub-plurality of frames and a second sub-plurality of frames, and wherein colors of the first subset of pixels and the second subset of pixels in the first sub-plurality of frames are different from colors of the first subset of pixels and the second subset of pixels in the second sub-plurality of frames.

6. The method of claim 5, wherein the first sub-plurality of frames is displayed for a first set of time periods and the second sub-plurality of frames is displayed for a second set of time periods.

7. The method of claim 6, wherein the first set of time periods and the second set of time periods are determined using a pseudo-random sequence.

8. The method of claim 1, wherein the modified UI is displayed during a live phase of the video conference or during a preparation phase of the video conference.

9. The method of claim 1, wherein the video stream generated by the first client device subsequent to the presentation of the modified UI reflects color changes to one or more objects in an image captured by a camera of the first client device, wherein the color changes are caused by the color pattern encoding modifying illumination of the one or more objects by a display of the first client device.

10. The method of claim 1, wherein verifying the integrity of the video content generated by the first client device comprises:
providing the video stream generated by the first client device and the color pattern encoding as input to a trained artificial intelligence (AI) model;
receiving an output of the trained AI model, the output indicating a likelihood of a color pattern of the video stream corresponding to the color pattern encoding; and
upon determining that the likelihood satisfies a threshold criterion, confirming the integrity of the video content generated by the first client device.

11. The method of claim 1, wherein verifying the integrity of the video content generated by the first client device is further based on latency between causing the modified UI to be presented on the first client device and receiving, from the first client device, the video stream generated by the first client device subsequent to the presentation of the modified UI on the first client device.

12. The method of claim 1, wherein determining that the integrity verification of the video content generated by the first client device is to be performed comprises at least one of:
receiving a request from a first participant of the plurality of participants of the video conference;
receiving an indication of a start of the video conference; or
detecting, using a plurality of rules, one or more candidate integrity verification threats, wherein the one or more candidate integrity verification threats pertains to one or more of: a connection pattern, a network condition, an internet protocol (IP) geolocation, a virtual private network (VPN) use, or a number of connection attempts.

13. A system comprising:
a memory device; and
a processing device coupled to the memory device, the processing device to perform operations comprising:
determining that an integrity verification of video content generated by a first client device of a plurality of client devices of a plurality of participants of a video conference is to be performed;
causing a modified user interface (UI) comprising one or more visual items, each corresponding to a video stream generated by one of the plurality of client devices, to be presented on the first client device, wherein the UI was modified using a color pattern encoding;
receive, from the first client device, a video stream generated by the first client device subsequent to a presentation of the modified UI on the first client device; and
verify the integrity of the video content generated by the first client device based on the video stream generated by the first client device and the color pattern encoding.

14. The system of claim 13, wherein the color pattern encoding modifies a plurality of frames presented in the modified UI, each of the plurality of frames comprises a first subset of pixels with a modified first color pattern and a second subset of pixels with a modified second color pattern.

15. The system of claim 14, wherein the first subset of pixels with the modified first color pattern and the second subset of pixels with the modified second color pattern correspond to the one or more visual items in the modified UI.

16. The system of claim 14, wherein the modified first color pattern comprises a first red-green-blue (RGB) color, and the modified second color pattern comprises a second RGB color that is complementary to the first RGB color, and wherein the first RGB color and the second RGB color are selected such that combined color modifications maintain color neutrality of the modified UI.

17. A non-transitory computer readable storage medium comprising instructions for a server that, when executed by a processing device, cause the processing device to perform operations comprising:
determining that an integrity verification of video content generated by a first client device of a plurality of client devices of a plurality of participants of a video conference is to be performed;
causing a modified user interface (UI) comprising one or more visual items, each corresponding to a video stream generated by one of the plurality of client devices, to be presented on the first client device, wherein the UI was modified using a color pattern encoding;
receive, from the first client device, a video stream generated by the first client device subsequent to a presentation of the modified UI on the first client device; and
verify the integrity of the video content generated by the first client device based on the video stream generated by the first client device and the color pattern encoding.

18. The non-transitory computer readable storage medium of claim 17, wherein the color pattern encoding modifies a plurality of frames presented in the modified UI, each of the plurality of frames comprises a first subset of pixels with a modified first color pattern and a second subset of pixels with a modified second color pattern.

19. The non-transitory computer readable storage medium of claim 18, wherein the first subset of pixels with the modified first color pattern and the second subset of pixels with the modified second color pattern correspond to the one or more visual items in the modified UI.

20. The non-transitory computer readable storage medium of claim 18, wherein the modified first color pattern comprises a first red-green-blue (RGB) color, and the modified second color pattern comprises a second RGB color that is complementary to the first RGB color, and wherein the first RGB color and the second RGB color are selected such that combined color modifications maintain color neutrality of the modified UI.
